(19) United States
(12) Patent Application Publication
(10) Pub. No.: US 2005/0139157 A1
(43) Pub. Date: Jun. 30, 2005

(54) Nozzle array

(76) Inventors: Vilho Nissinen, Numminen (FI); Mika Linjamaki, Jarvenpaa (FI); Jussi Nykanen, Helsinki (FI)

Correspondence Address: STIENNON & STIENNON, 612 W. MAIN ST., SUITE 201, P.O. BOX 1667, MADISON, WI, 53701-1667, US

(21) Appl. No.: 10/501,607

(22) PCT Filed: Jan. 14, 2003
(86) PCT No.: PCT/FI03/00022

(30) Foreign Application Priority Data
Jan. 15, 2002 (FI) 20020073

(51) Int. Cl. B05B 7/06; B05C 5/00

(52) U.S. Cl. 118/313

(57) ABSTRACT

A nozzle array for use in the coating of a mobile web-like material has a plurality of high-pressure nozzles (2.1, 2.2) in the transverse direction of the web. The nozzles (2.1, 2.2) have been classified by a variable acting on the flow so that the deviation of the variable within the array is smaller than a pre-set value. The yield of each nozzle being the same with optimal precision, an optimally even coating is achieved on the web.

### CROSS REFERENCES TO RELATED APPLICATIONS

This application is a U.S. national stage application of International App. No. PCT/FI03/00022, filed Jan. 14, 2003, and claims priority on Finnish App. No. 20020073, filed Jan. 15, 2002.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The invention relates to the coating of a mobile web-like material with high-pressure spraying techniques and is directed to the nozzle array used in such coating. The invention is especially applicable to paper coating.

In paper coating, a liquid coating mixture intended especially to improve printability is applied to the paper surface. Presses, blade applicators and film transfer devices are conventionally used for this purpose. When an increase in the drive rate is called for or papers with continually decreasing thickness are coated, these techniques are difficult to implement reliably in the practice.

Spray coating has appeared as one of the most recent coating techniques. It has the particular advantage of not requiring any mechanical coating means in contact with the web, such as an abrasive blade or a rotating rod. The spray technique called high-pressure spray technique has proved particularly promising; it comprises driving merely a coating mixture without any gaseous medium under high pressure through a nozzle with a small hole, so that the mixture is atomized into small droplets. The pressure may be e.g. 1 to 200 MPa and the nozzle opening area e.g. 0.02 to 0.5 mm². A typical maximum droplet size is about 100 μm. Such an apparatus comprises a nozzle array with one or more nozzle rows consisting of several nozzles in the transverse direction of the web. The nozzles are disposed so as to provide a coating jet on the web that covers the web as evenly as possible. Then the jets generated by adjacent nozzles in a nozzle row suitably overlap at their edges. The coating mixture is distributed under the same pressure from one single feed pipe to each nozzle. This allows the flow of only the nozzles fed together to be adjusted by varying the pressure, the concentration or the viscosity. The jet shape provided by the nozzles depends on the shape of the nozzle opening. The general aim is to provide a jet having a larger width in the transverse direction of the web than in its longitudinal direction. The nozzle opening is then accordingly oval.

Paper coating by spraying is described e.g. in the publications FI B 108061 (corresponding to WO 9717036) and Nissinen V, OptiSpray, the New Low Impact Paper Coating Technology, OptiSpray Coating and Sizing Conference, Finland, 15 Mar. 2001.

### SUMMARY OF THE INVENTION

The nozzle array of this invention is for use in coating of a web-like material. It has now been found that deviation in the dimensions of the nozzle openings has a substantial impact both on the flow passing through the nozzle (yield) and on the jet shape. This results in a corresponding deviation of the coating formed on the web. Accordingly, it has been found that classifying the nozzles in advance on the basis of a variable correlating with the yield deviation can diminish the yield deviation of the nozzle array. The nozzles are classified so as to keep the deviation of the variable from the mean within the array under the permissible quality requirement. The requirement may be e.g. under ±5%, such as under ±2%.

The nozzle variable to be measured may be especially the nozzle opening area. The area can be determined especially by optical methods. The determination may e.g. comprise leading a light beam, such as a laser beam, to the opening, and measuring the portion of the beam retained by the opening. The area can also be directly obtained e.g. as pixels on the image surface of a CCD camera. Instead of the area, the width and the length of the opening can be determined, using their product as a variable. These can also be optically determined using a microscope, for instance. Optical measuring methods are also easy to automate.

With the nozzles classified as described above, the nozzle array yields a coating distribution on the web that is as even as possible and also remains as even as possible as the nozzles wear. The coating can be achieved with the desired thickness within each array by altering the feed values whenever necessary. The classification described here is considerably more rapid and simple than classification based directly on flow measurements of the nozzles. Used nozzles can be returned and reclassified.

The invention is applicable e.g. to the classification of nozzles to be used for coating papers such as printing papers or cardboards. A classified nozzle array yields a coating of optimally even quality.

### BRIEF DESCRIPTION OF THE DRAWINGS

Some embodiments of the invention are described in detail below. The accompanying drawings pertain to the description.

FIG. 1 shows the distribution of the yield and fan width of an unclassified nozzle array.

FIG. 2 shows the change in the yield deviation of a nozzle array as the nozzles wear.

FIG. 3 shows a typical deviation of the yield of a nozzle array and its classification in accordance with the invention.

FIG. 4 shows optical measurement of the nozzle area.

FIG. 5 shows the position of the two outermost nozzles in the nozzle array and the distribution of the coating achieved with these.

### DESCRIPTION OF THE PREFERRED EMBODIMENTS

The manufacturing processes used by nozzle manufacturers are inaccurate. Manufacturers report a volume flow variation of the order of +5% at the most for the nozzles. In the practice, this signifies that there may be a 10% variation in the coating amount profile. However, practical observations show that nozzles taken from a manufacturing batch of nozzles of the same nominal size may have a yield deviation of over ±10% from the determined mean yield.

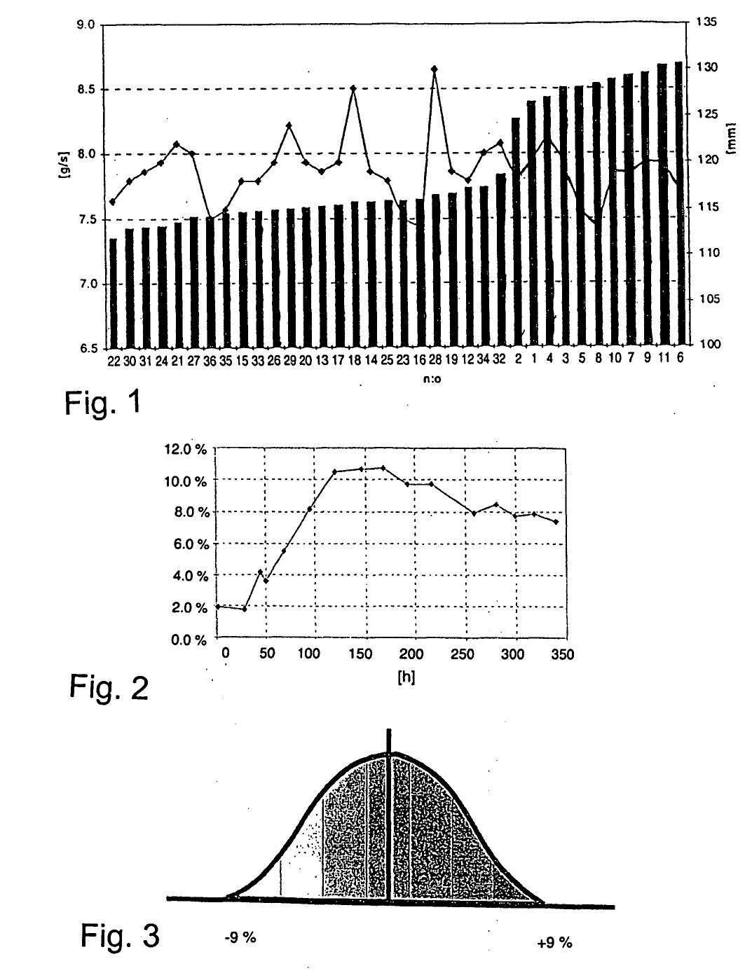

The inventors examined the mass flow provided by each nozzle in a typical batch of 36 nozzles and the width of the jet fan using water under a pressure of 100 bars. The nominal diameter of the nozzles was 0.3 mm. The results are shown in FIG. 1. The bars show the yield, and the curve shows the width of the jet fan.

It was also observed that, as the nozzles wear, the yield deviation tends to increase further. In fact, coating mixtures often contain solid substances, such as pigments, which accelerate wear. This issue was studied on a batch of nine nozzles by spraying a coating paste containing calcium carbonate and by monitoring the change in the volume flow deviation in the course of the operating time of the nozzles. The results are shown in FIG. 2.

Consequently, it is of paramount importance that each nozzle in a nozzle array has the same initial yield with adequate accuracy. In this manner, a coating of optimally even quality is obtained.

For classifying the nozzles, a variable correlating with the yield is selected, which is determined for each nozzle. In terms of flow rate techniques, the nozzle opening area shows the most exact correlation with the flow. A satisfactory result is also obtained by measuring the diameter of the flow opening at one or more points. In the case of an oval opening, for instance, the width and the height can be determined. When these variables of the nozzle are substantially mutually equal, the mutual yields will also be equal.

Only nozzles having a deviation of the determined variable lower than the allowable nominal deviation are mounted in the same nozzle array. The permissible limit may be e.g. ±2%.

FIG. 3 shows a typical deviation of the flow rate of a nozzle array, which has been divided into acceptable part arrays.

One way of classifying nozzles is to measure with a microscope the width and height of the nozzle opening and to use the product of these as a classification variable. A 100-fold magnifying microscope achieves 0.001 mm precision. Table 1 shows the dimensions of the holes of a batch of 10 nozzles and the corresponding mass flow. The mass flow was obtained by spraying water under a pressure of 100 bars for 2 minutes into a vessel and by weighing the water amount.

TABLE 1

| Nozzle | | | | |
|---|---|---|---|---|
| no | Width/mm | Length/mm | Length * width/mm² | Mass flow/g/s |
| 1 | 0.530 | 0.240 | 0.1272 | 12.6 |
| 2 | 0.525 | 0.235 | 0.1234 | 12.2 |
| 3 | 0.515 | 0.230 | 0.1185 | 11.8 |
| 4 | 0.515 | 0.230 | 0.1185 | 11.8 |
| 5 | 0.520 | 0.240 | 0.1248 | 12.4 |
| 6 | 0.515 | 0.235 | 0.1210 | 12.2 |
| 7 | 0.520 | 0.230 | 0.1196 | 12.0 |
| 8 | 0.500 | 0.225 | 0.1125 | 11.2 |
| 9 | 0.530 | 0.223 | 0.1182 | 11.6 |
| 10 | 0.515 | 0.230 | 0.1185 | 11.8 |

The width of an oval nozzle opening multiplied with its height is naturally greater than the opening area, but correlates perfectly well with the mass flow.

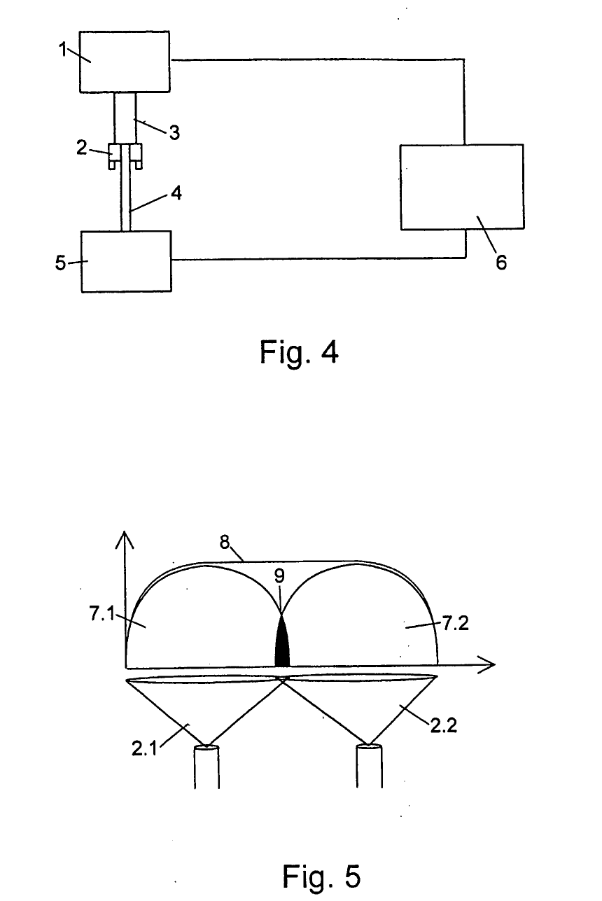

The nozzle opening area can be determined with high precision using e.g. the arrangement of FIG. 4. In this, a laser beam 3 having a diameter larger than the opening is taken from a laser source 1 to the opening of the nozzle 2. Having passed through the opening, the laser beam 4 is determined with a detector 5. The control and computing unit 6 calculates the difference between the laser beams, and using this as a basis, the opening area and also the main dimensions are calculated if desired. The results can be shown on a display. Such measuring apparatuses are commercially available (e.g. Keyence).

Optical measuring of the kind described above can also easily be automated.

FIG. 5 shows the jet patterns 7.1 and 7.2 formed by fan-shaped jets of the two outermost nozzles 2.1 and 2.2 in a nozzle array and the weight distribution 8 of the formed coating. The jet edges are adequately overlapped in the intermediate area 9, so that the amount of coating becomes constant also in the area between the nozzles. When the nozzles have been classified in advance in accordance with the invention, the weight distribution will be optimally even across the entire web.

1-6. (canceled)

7. A nozzle array for use in coating a paper web, comprising:
a plurality of liquid coating nozzles arrayed in a transverse direction across the web, the nozzles connected to a source of high-pressure liquid coating, the nozzles arranged to spray a coating mixture onto the web;
wherein each nozzle of the array defines a nozzle open area, and each nozzle has an acting variable proportional to liquid coating flow through said nozzle; and
wherein for all the nozzles of the array, the acting variable varies from a mean by less than 5% of the mean.

8. The nozzle array of claim 1 wherein the acting variable varies from a mean by less than 2% of the mean.

9. The nozzle array of claim 1 wherein the acting variable is the defined nozzle open area.

10. The nozzle array of claim 1 wherein each nozzle of the array defines a diameter and the acting variable is the defined diameter.

11. A method of coating a paper web comprising the steps of:
selecting a plurality of high-pressure liquid coating nozzles, wherein each nozzle has an acting variable value, said acting variable value being proportional to a liquid volume coating flow through said nozzle at a given pressure;
further selecting each of the plurality of high-pressure liquid coating nozzles so that the acting variable varies from a mean of all the nozzles of the array by less than 5% of the mean;
connecting the plurality of high-pressure liquid coating nozzles to a source of high-pressure liquid coating; and
spraying the paper web with said plurality of high-pressure liquid coating nozzles wherein the nozzles are arranged to achieve an even coating on the paper web.

12. The method of claim 11 wherein the acting variable varies from a mean by less than 2% of the mean.

13. The method of claim 11 wherein the acting variable varies is the defined nozzle open area.

14. The method of claim 11 wherein the acting variable for each nozzle is determined optically.

15. The method of claim 11 wherein each nozzle of the array defines a nozzle open area and wherein the acting variable is determined by a plurality of measurements of diameter of a throat which forms the nozzle open area.

16. The method of claim 15 wherein the measurements of diameter are determined optically.
